(19) United States
(12) Patent Application Publication
(10) Pub. No.: US 2013/0263765 A1
(43) Pub. Date: Oct. 10, 2013

(54) PIPE INSULATION

(71) Applicant: David Raymond Merrick, Ledbury (GB)

(72) Inventor: David Raymond Merrick, Ledbury (GB)

(73) Assignee: LINTHWAITE LIMITED, Ledbury (GB)

(21) Appl. No.: 13/440,536

(22) Filed: Apr. 5, 2012

(51) Int. Cl. F24H 8/00; F16L 11/12; B23P 11/00; F16L 59/153

(52) U.S. Cl. 110/203; 138/32; 138/137; 138/148; 122/18.1; 29/428

(57) ABSTRACT

Pipe insulation, such as may be used to insulate the condensate pipe of a heating appliance such as condensing boiler, the pipe insulation comprising a flexible internal conduit surrounded by a flexible layer of insulation, in which the layer of insulation comprise fibers between which is trapped air. Typically, the insulation layer can comprise a silica nanoporous aerogel with reinforcing fibers.

### BACKGROUND OF THE INVENTION

1. Field of the Invention

This invention relates to pipe insulation.

2.Description of the Related Art

Condensing boilers are well known; they burn fuel such as gaseous (natural gas, liquefied petroleum gas, butane, propane, etc) or liquid (heating oil, kerosene, etc) hydrocarbons in order to heat a fluid generally being water. The burning of the fuel results in exhaust gasses being produced. In order to increase efficiency, water in the exhaust gasses is condensed, thus recovering the latent heat of condensation into the water (or other material) to be heated.

However, this condensate needs to be disposed of. Typically, a condensate drain is provided, which comprises a pipe leading to a suitable disposal point. Often, such pipes are routed externally and so are subject to the local weather. If the temperature is less than the freezing point of water, there is a danger that the condensate in the pipe could freeze, blocking the pipe. Blockage of the pipe can lead to malfunction of the boiler; typically, most boilers will sense a blockage and shut down.

In order to avoid such blockages, standard pipe lagging could be used. This is generally formed of closed cell foam, which is used to surround the pipe. Generally, lagging is provided in the form of a flexible annular cylinder, with a slit along the length, the slit allowing the lagging to be passed over the pipe so that the pipe lies within a central void of the lagging. However, this is bulky and unsightly, and it is desired to improve the efficiency of such an arrangement.

### BRIEF SUMMARY OF THE INVENTION

According to a first aspect of the invention, there is provided pipe insulation comprising a flexible internal conduit surrounded by a flexible layer of insulation, in which the layer of insulation comprise fibers between which is trapped air.

Thus, we provide flexible pipe insulation, insulated in a particularly efficient manner, with a central internal conduit which can typically be used to transmit liquid. As such, the pipe insulation may be receivable within a pipe to be insulated. In such a case, the pipe is internally, rather than externally, insulated, with the internal conduit providing a replacement channel for the flow through the bore of the pipe. Because the pipe insulation is flexible, it may be able to follow the path of the pipe through curved sections of pipe. There will typically be no need to increase the diameter of the insulated pipe.

The layer of insulation may be surrounded by a containment layer which acts to prevent the escape of the fibers. This containment layer may comprise a wrapping for the pipe insulation, and typically will comprise a thin flexible plastic layer, typically formed of low density polyethylene. The containment layer will typically be very much thinner than the layer of insulation; typically, the layer of insulation will be less than 10 millimeters thick, preferably in the range 2.5 mm to 7.5 mm, whereas the containment layer will typically only be around one micrometer hick. Such a layer allows more efficient, fiber-containing insulation materials to be used.

The layer of insulation may comprise a nanoporous aerogel, typically a silica aerogel, with reinforcing fibers. Such insulation has been found to function particularly well to insulate the internal conduit from its surroundings.

The internal conduit may be formed of plastic materials, such as polyvinylchloride (PVC, typically unplasticized PVC otherwise known as uPVC) or polypropylene.

Typically, the internal conduit will be corrugated, so as to allow the internal conduit and hence the pipe insulation to flex. Corrugations in the internal pipe may also act to trap air and hence insulate the internal conduit from its surroundings.

According to a second aspect of the invention, there is provided an insulated pipe, comprising an external pipe having a bore in which is received the pipe insulation in accordance with the first aspect of the invention.

Typically, the pipe will be a condensate drain pipe of a heating appliance such as a condensing boiler.

According to a third aspect of the invention, there is provided a heating appliance having a condensate drain pipe, the condensate drain pipe having a bore in which is received pipe insulation in accordance with the first aspect of the invention.

The internal conduit may be coupled to the heating appliance such that condensate from the heating appliance flows through the internal conduit.

Typically, the heating appliance will be a condensing boiler.

According to a fourth aspect of the invention, there is provided a method of insulating a pipe having a bore, comprising inserting pipe insulation according to the first aspect of the invention into the bore.

The method may comprise connecting the pipe to at least one of an inlet at which fluid is introduced, and an outlet at which fluid leaves the pipe. The method may comprise connecting the internal conduit to at least one of the inlet and the outlet such that fluid flows through the internal conduit.

The inlet may be a condensate drain of a heating appliance such as a condensing boiler.

As such, the method may conveniently provide a method of retrofitting insulation to a previously uninsulated pipe.

### BRIEF DESCRIPTION OF THE SEVERAL VIEWS OF THE DRAWINGS

There now follows, by way of example only, an embodiment of the invention, described with reference to, and as illustrated in the accompanying drawings, in which:

FIG. 1 shows a cut away view of a pipe insulated in accordance with an embodiment of the invention;

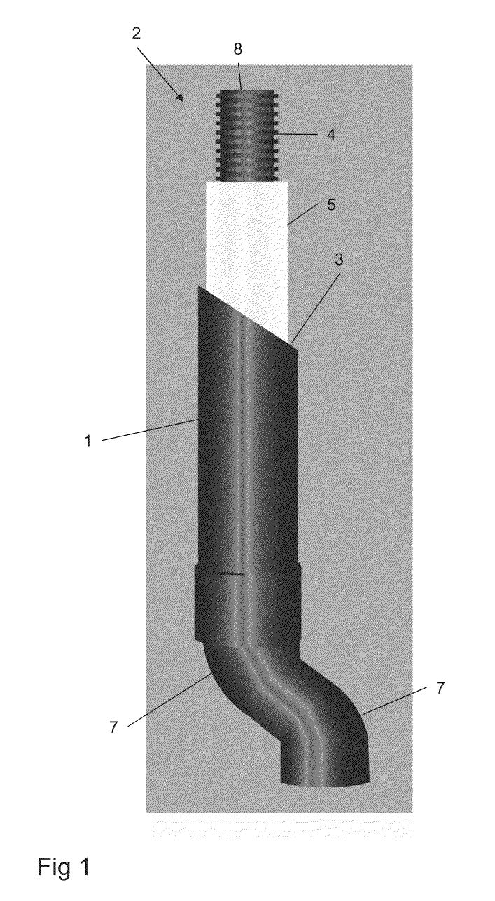

FIG. 2 shows a cross sectional exploded view through the insulated pipe of FIG. 1; and

FIG. 3 shows a schematic view of a heating system using the insulated pipe of FIG. 1 as the condensate drain pipe.

### DETAILED DESCRIPTION OF THE INVENTION

A pipe 1 which has been internally insulated with insulation 2 is shown in the accompanying drawings. The insulation 2 is fitted internally in the bore 3 of the pipe 1.

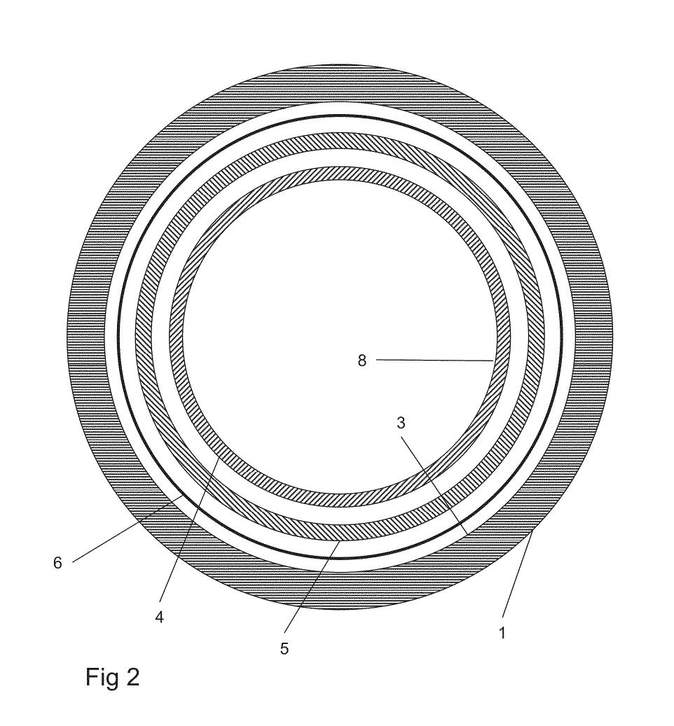

The insulation 2 comprises a flexible internal conduit 4 surrounded by an insulation layer 5. As can be seen in FIG. 2 of the accompanying drawings, the insulation layer 5 is surrounding by a wrapping layer 6, so that the insulation layer 5 is trapped between the wrapping layer 6 and the internal conduit 4.

Given that the internal conduit 4, the insulating layer 5 and the wrapping layer 6 are all flexible, the insulation 2 as a whole is flexible. This means that the insulation 2 can accommodate for bends 7 in the pipe without the need for joins.

The internal conduit 4 is typically formed of polypropylene. At least in part, its flexibility arises from the fact that the internal conduit is ribbed or corrugated. The internal conduit 4 has an internal bore 8 through which fluid can flow.

The insulating layer 5 may comprise a nanoporous aerogel having reinforcing fibers. Such a product is available from Aspen Aerogels, Inc., of Northborough, Mass., United States of America, under the brand name SPACELOFT®. The insulation layer is typically around 5 millimeters thick. Such a product is a particularly efficient insulator.

The wrapping layer 6 therefore prevents the material of the insulating layer escaping. The wrapping layer 6 is an roughly 1 micrometer thick plastic wrapping material (such as low density polyethylene material).

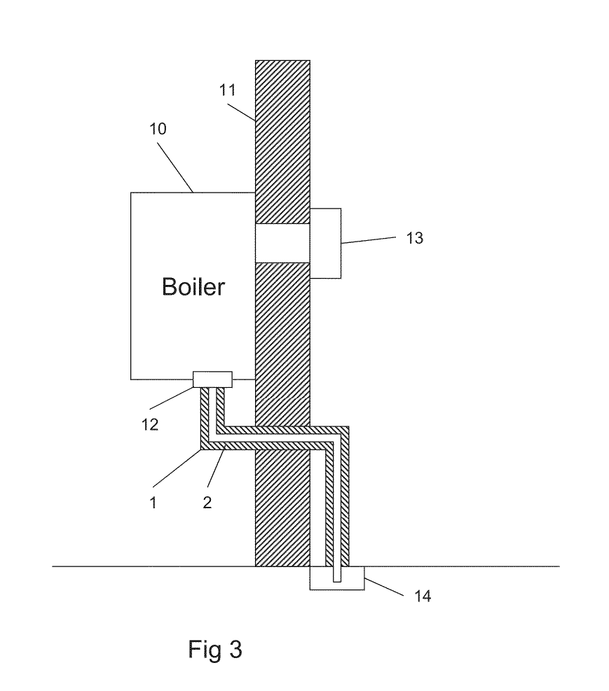

An embodiment of the insulated pipe in use can be seen in FIG. 3 of the accompanying drawings. In this embodiment, a condensing boiler 10 is mounted on the internal side of an external wall 11 of a house. The boiler 10 is a condensing boiler; that is, a boiler that burns fuel such as gaseous (natural gas, liquefied petroleum gas, butane, propane, etc) or liquid (heating oil, kerosene, etc) hydrocarbons in order to heat water for use in the house. The burning of the fuel results in exhaust gasses being produced, which are emitted outside the house through a flue 13.

In order to increase efficiency, water in the exhaust gasses is condensed, thus recovering the latent heat of condensation into the water to be heated. As such, this results in condensate being formed, which must be disposed of.

In order to dispose of the condensate, the boiler 10 is provided with a condensate output 13. This is coupled to a pipe 1, having insulation 2 as described above. The internal conduit 4 of the insulation 2 is coupled to the condensate output 13, so that condensate flows through the bore 8 of the internal conduit 4. The insulated pipe 1 carries the condensate through the wall 11 to an external drain 14.

Because of the insulation 2, the pipe 1 can allow the passage of condensate even in low temperatures. In tests of a 5.4 meter long pipe with a slope of 50 millimeters per meter, and a flow rate of 500 milliliters per hour, the insulated pipe did not block for over 8 hours with temperatures as low as −15 degrees centigrade.

This pipe insulation 2 can be used to retrofit existing uninsulated pipes. In such a case, the insulation 2 is inserted into the bore 3 of an existing pipe 1; given the flexibility of the insulation 2, the insulation 2 will pass around any bends 7. The internal conduit is then attached to the outlet and/or discharge for whatever fluid is to be conveyed by the pipe 1 and to which the pipe 1 was previously coupled. Thus, insulation can be provided without increasing the space occupied by the pipe 1.

1. Pipe insulation comprising a flexible internal conduit surrounded by a flexible layer of insulation, in which the layer of insulation comprise fibers between which is trapped air.

2. The pipe insulation of claim 1, in which the pipe insulation is receivable within a pipe to be insulated.

3. The pipe insulation of claim 1, in which the layer of insulation is surrounded by a containment layer which acts to prevent the escape of the fibers.

4. The pipe insulation of claim 3, in which the containment layer comprises a wrapping for the pipe insulation

5. The pipe insulation of claim 1, in which the layer of insulation comprises a nanoporous aerogel with reinforcing fibers.

6. The pipe insulation of claim 5, in which the nanoporous aerogel is a silica aerogel.

7. An insulated pipe, comprising an external pipe having a bore in which is received pipe insulation comprising a flexible internal conduit surrounded by a flexible layer of insulation, in which the layer of insulation comprise fibers between which is trapped air.

8. The insulated pipe of claim 7, in which the pipe is a condensate drain pipe of a heating appliance being a condensing boiler.

9. A heating appliance having a condensate drain pipe, the condensate drain pipe having a bore in which is received pipe insulation comprising a flexible internal conduit surrounded by a flexible layer of insulation, in which the layer of insulation comprise fibers between which is trapped air.

10. The heating appliance of claim 9, in which the internal conduit is coupled to a condensate outlet of the heating appliance such that condensate from the heating appliance flows through the internal conduit.

11. A method of insulating a pipe having a bore, comprising inserting into the bore pipe insulation comprising a flexible internal conduit surrounded by a flexible layer of insulation, in which the layer of insulation comprise fibers between which is trapped air.

12. The method of claim 11, comprising the step of connecting the pipe to at least one of an inlet at which fluid is introduced and an outlet at which fluid leaves the pipe and connecting the internal conduit to at least one of the inlet and the outlet such that fluid flows through the internal conduit.

13. The method of claim 12 in which the inlet is a condensate drain of a heating appliance.

14. The method of claim 11, in which the pipe was previously uninsulated.
